(19) United States
(12) Patent Application Publication
(10) Pub. No.: US 2025/0383179 A1
(43) Pub. Date: Dec. 18, 2025

(54) SOLAR PHOTOVOLTAIC MODULE, SIGHT AND SHOOTING DEVICE

(71) Applicant: PSG Opto Development Co., Ltd, Shenzhen (CN)

(72) Inventor: San SU, Shenzhen (CN)

(73) Assignee: PSG Opto Development Co., Ltd, Shenzhen (CN)

(21) Appl. No.: 19/226,742

(22) Filed: Jun. 3, 2025

(30) Foreign Application Priority Data
Jun. 12, 2024 (CN) 202421336661.7

(51) Int. Cl. F41G 1/34; H02S 20/30

(52) U.S. Cl. CPC F41G 1/345; H02S 20/30

(57) ABSTRACT

Related to the field of sight application, a solar photovoltaic module, a sight and a shooting device are provided. The solar photovoltaic module includes: a substrate, the substrate includes a sight connection end and a chip fixing end arranged opposite to each other, the sight connection end is used to connect a top of the sight; a plurality of photoelectric chips, the plurality of photoelectric chips are evenly spaced and arranged on the chip fixing end; and a plurality of photosensitive sensors, the plurality of photosensitive sensors are arranged on the chip fixing end, and the photoelectric chips are spaced from the photosensitive sensors. Thus, the photosensitive sensors can improve the effect of detecting the illumination of a shooting target or an area surrounding the shooting target, thereby greatly improving the adaptive adjustment effect of the brightness of light emitted by the light emitting diode module.

### CROSS-REFERENCE TO RELATED APPLICATIONS

The present disclosure claims priority to Chinese Patent Application No. 202421336661.7, filed on Jun. 12, 2024, the content of all of which is incorporated herein by reference.

### FIELD

The present disclosure relates to the technical field of sight application, and in particular to a solar photovoltaic module, a sight and a shooting device.

### BACKGROUND

An internal red-dot sight, regarded as a next-generation aiming technology, is also referred to as an internal red-dot scope. This device utilizes electronic imaging technology to project an aiming dot or reticle onto a surface of the sight, and features the ability to conceal the emitted light from a light emitting diode (LED) module.

To enhance the battery life and environmental adaptability of the sight, internal red-dot module typically incorporates a solar cell power supply module. The solar cell power supply module harnesses sunlight to generate electricity and supply power to the LED module, thereby conserving battery energy and automatically adjusting the brightness of the LED module according to ambient light intensity, without requiring manual intervention.

However, in existing internal red-dot modules powered by solar cells, a photoelectric sensor used for detecting the illumination level of a shooting target or its surrounding area is typically disposed within the module. As a result, the photoelectric sensor exhibits limited sensitivity to changes in ambient light intensity, thereby adversely affecting the adaptive adjustment of the brightness of the emitted light from the LED module.

Therefore, the existing technology has defects and deficiencies, which still needs to be improved and developed.

### SUMMARY

In view of the above-mentioned deficiencies in the prior art, the purpose of the present disclosure is to provide a solar photovoltaic module, a sight and a shooting device, aiming to solve the problem in the prior art that the photoelectric sensor is disposed in the sight, resulting in the photoelectric sensor exhibits limited sensitivity to changes in ambient light intensity.

A technical solution adopted by the present disclosure to solve the technical problem is as follows: a solar photovoltaic module for a sight, including:
a substrate, the substrate includes a sight connection end and a chip fixing end arranged opposite to each other, the sight connection end is adopted to connect to a top of the sight;
   a plurality of optoelectronic chips, the plurality of optoelectronic chips are evenly spaced and arranged on the chip fixing end;
   a plurality of photosensitive sensors, the plurality of photosensitive sensors are arranged on the chip fixing end, and the optoelectronic chips are spaced from the photosensitive sensors.

Optionally, the substrate is a planar substrate, a flexible substrate or a curved substrate.

Optionally, the plurality of optoelectronic chips are connected in series.

Optionally, a photosensitive electrode group and a photoelectric electrode group are arranged on the sight connection end; the photosensitive electrode group is electrically connected to the plurality of photosensitive sensors, and the photoelectric electrode group is electrically connected to the plurality of photoelectric chips.

Another technical solution adopted by the present disclosure to solve the technical problem is as follows:

A sight including a sight body and the above-mentioned solar photovoltaic module arranged on an outer surface of the sight body.

Optionally, the sight includes:
a power management module, the power management module is electrically connected to the photoelectric electrode group;
an MCU, the MCU is connected in series to the power management module, and the MCU is electrically connected to the photosensitive electrode group.

Optionally, the power management module is connected in parallel to the plurality of optoelectronic chips; and the MCU is used to control a quantity of the plurality of optoelectronic chips in on or off state.

Optionally, the sight further includes a light emitting diode module, and the light emitting diode module is electrically connected to the MCU.

Optionally, the sight further includes a power supply, and the power supply is electrically connected to the power management module; when the plurality of photosensitive sensors sense light, the MCU controls the power management module to switch to powering the optoelectronic chips, driving the light emitting diode module to emit light; when the plurality of photosensitive sensors do not sense light, the MCU controls the power management module to switch to powering the power supply, driving the light emitting diode module to emit light.

Another technical solution adopted by the present disclosure to solve the technical problem is as follows: a shooting device, including the sight as described above.

Compared with the prior art, the present disclosure provides a solar photoelectric module, a sight, and a shooting device. By disposing photoelectric chips and photosensitive sensors on a top of the sight, with several photosensitive sensors arranged on the chip fixing end and spaced apart from the photoelectric chips, the photosensitive sensors can improve the detection of illumination levels of a shooting target or an area surrounding the shooting target, thereby significantly enhancing the adaptive adjustment of a brightness of light emitted by an LED module.

### BRIEF DESCRIPTION OF THE DRAWINGS

FIG. 1 is a top view of the solar photovoltaic module according to the present disclosure;

FIG. 2 is a bottom view of the solar photovoltaic module according to the present disclosure;

FIG. 3 is another top view of the solar photovoltaic module according to the present disclosure;

FIG. 4 is a schematic diagram of a three-dimensional structure of the sight and the solar photovoltaic module according to the present disclosure;

FIG. 5 is a block diagram showing a functional principle of the circuit board of the sight according to the present disclosure.

### DETAILED DESCRIPTION OF EMBODIMENTS

The embodiments of the present disclosure are described in detail below, and examples of the embodiments are shown in the accompanying drawings, while the same or similar reference numerals throughout represent the same or similar elements or elements having the same or similar functions. The embodiments described below with reference to the accompanying drawings are exemplary and are only used to explain the present disclosure, and cannot be understood as limiting the present disclosure.

In the description of the present disclosure, it should be understood that the terms “center”, “longitudinal”, “lateral”, “up”, “down”, “front”, “back”, “left”, “right”, “vertical”, “horizontal”, “top”, “bottom”, “inside”, “outside” and the like indicate positions or positional relationships based on the positions or positional relationships shown in the accompanying drawings, and are only for the convenience of describing the present disclosure and simplifying the description, rather than indicating or implying that the device or element referred to must have a specific orientation, be constructed and operated in a specific orientation, and therefore cannot be understood as a limitation on the present disclosure. In addition, the terms “first” and “second” are used for descriptive purposes only, and cannot be understood as indicating or implying relative importance or implicitly indicating the number of technical features indicated. Thus, the features defined as “first” and “second” may explicitly or implicitly include one or more of the features. In the description of the present disclosure, unless otherwise specified, “multiple” means two or more.

In the description of the present disclosure, it should be noted that, unless otherwise clearly specified and limited, the terms “install”, “connect”, and “couple” should be understood in a broad sense, for example, it can be a fixed connection, a detachable connection, or an integral connection; it can be a mechanical connection or an electrical connection; it can be a direct connection, or it can be indirectly connected through an intermediate medium, or it can be the internal communication of two components. For ordinary technicians in this field, the specific meanings of the above terms in the present disclosure can be understood according to specific circumstances.

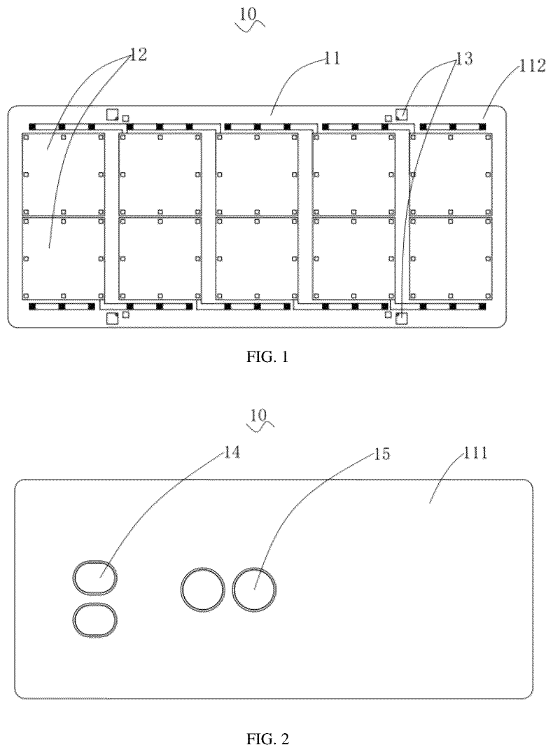

As shown in FIG. 1 and FIG. 4 in combination, a first embodiment of the present disclosure provides a solar photovoltaic module 10 for a sight 20. When photosensitive sensors 13 sense light, an MCU 22 detects a current change at a photosensitive electrode group 14, and controls a power management module 21 to switch to a plurality of photoelectric chips 12 to drive a light emitting diode module 23 to emit light. The MCU 22 can adjust the number of the photoelectric chips 12 connected to the power management module 21 according to an intensity of the current change detected at the photosensitive electrode group 14, thereby automatically adjusting a brightness of the light emitting diode module 23 to avoid the light emitted by the light emitting diode module 23 being too bright that may affect the use of the sight 20. When the light is insufficient or being used at night, the MCU 22 cannot detect the current change of the photosensitive electrode group 14, and then controls the power management module 21 to switch to the power supply 24 to ensure the normal use of the sight 20.

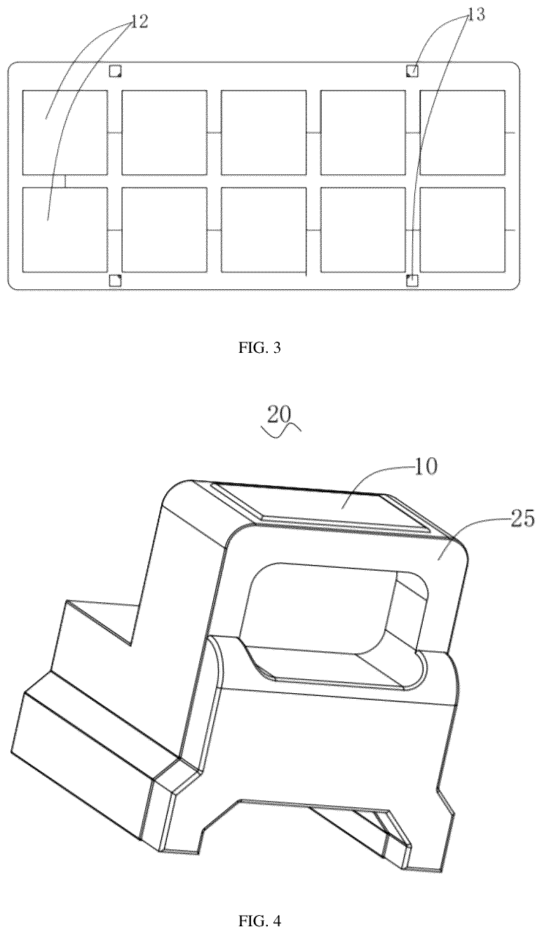

As shown in FIG. 1 and FIG. 2 in combination, the solar photovoltaic module 10 includes a substrate 11, a plurality of photovoltaic chips 12 and a plurality of photosensitive sensors 13. The substrate 11 has a sight connection end 111 and a chip fixing end 112 that are arranged opposite to each other, and the sight connection end 111 is used to connect a top of the sight 20, so that the photovoltaic chips 12 can receive sunlight to the maximum extent, thereby significantly improving the energy conversion efficiency of the photovoltaic chips 12 and providing a stable power supply for the sight 20. The plurality of photovoltaic chips 12 are evenly spaced on the chip fixing end 112. A plurality of photosensitive sensors 13 are arranged on the chip fixing end 112, and the photovoltaic chips 12 are spaced from the photosensitive sensors 13, thereby optimizing the efficiency of the photovoltaic chips 12 in receiving solar energy. Furthermore, the photosensitive sensors 13 are enabled to more directly and quickly sense and detect changes in the illumination of the shooting target or the area surrounding the shooting target, thereby improving a response speed and accuracy to the illumination change, and significantly developing the adaptive adjustment effect of the brightness of the light emitted by the light emitting diode module 23.

As shown in FIG. 1, in some embodiments, the substrate 11 is a flat substrate, a flexible substrate or a curved substrate, thereby improving the applicability and versatility of the solar photovoltaic module 10.

As shown in FIG. 3, in some embodiments, the plurality of optoelectronic chips 12 are connected in series, thereby simplifying the circuit structure, reducing wiring complexity, improving the stability and reliability of the optoelectronic chips 12, and thus improving the energy conversion efficiency of the optoelectronic chips 12.

As shown in FIG. 2, in some embodiments, the substrate 11 is further provided with a photosensitive electrode group 14 and a photoelectric electrode group 15. The photosensitive electrode group 14 includes a photosensitive cathode and a photosensitive anode. The photoelectric electrode group 15 includes a photoelectric anode and a photoelectric cathode. The photosensitive electrode group 14 and the photoelectric electrode group 15 are provided on the sight connection end, so as to facilitate the electrical connection between the photosensitive electrode group 14 and the photoelectric electrode group 15 and the circuit inside the sight 20, thereby improving the integration of the sight 20. The photosensitive electrode group 14 is electrically connected to the plurality of photosensitive sensors 13, and the photoelectric electrode group 15 is electrically connected to the plurality of photoelectric chips 12. The photosensitive electrode group 14 is used to supply power to the plurality of photosensitive sensors 13. The photoelectric electrode group 15 is used to output the power generation of the plurality of photoelectric chips 12.

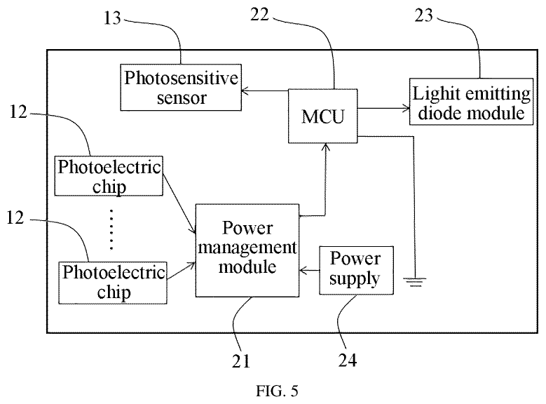

As shown in FIG. 4 and FIG. 5 in combination, in a second embodiment of the present disclosure, a sight 20 including a sight body 25 and the solar photovoltaic module 10 is provided. The solar photovoltaic module 10 is arranged on an outer surface of the sight body 25, thereby improving the endurance and environmental adaptability of the sight 20. So that the photosensitive sensor 13 can improve the effect of detecting the illumination of a shooting target or an area surrounding the shooting target, thereby greatly improving the adaptive adjustment effect of a brightness of light emitted by the light emitting diode module 23. So that the aiming point of the sight 20 can be clearly visible under different lighting conditions.

As shown in FIG. 5, in some embodiments, the sight 20 includes a power management module 21 and an MCU 22. The power management module 21 is electrically connected to the photoelectric electrode group 15, so that the power management module 21 can efficiently manage and utilize the electric energy output by the photoelectric chip 12. The MCU 22 is connected in series to the power management module 21, and the MCU 22 is electrically connected to the photosensitive electrode group 14. So that the MCU 22 can adjust the working state of the photoelectric chips 12 according to the current changes detected at the photosensitive electrode group 14.

As shown in FIG. 5, in some embodiments, the power management module 21 and the optoelectronic chips 12 are connected in parallel. The MCU 22 is used to control a quantity of the optoelectronic chips 12 in on or off state, so that the optoelectronic chips 12 can be flexibly connected to or disconnected from the power management module 21. The MCU 22 adjusts the working quantity and working state of the optoelectronic chips 12 according to the current changes detected at the photosensitive electrode group 14, thereby greatly improving the adaptive adjustment effect of the brightness of light emitted by the light emitting diode module 23.

As shown in FIG. 5, in some embodiments, the sight 20 also includes a light emitting diode module 23, which is electrically connected to the MCU 22. So that the MCU 22 can detect the current change at the photosensitive electrode group 14, thereby increasing the brightness of light from the light emitting diode module 23. Therefore, the aiming point of the sight 20 can be clearly seen under different lighting conditions.

As shown in FIG. 5, in some embodiments, the sight 20 also includes a power supply 24, which is electrically connected to the power management module 21. When the photosensitive sensors 13 sense light, the MCU 22 detects a current change at the photosensitive electrode group 14, the power management module 21 is controlled to switch to the plurality of photoelectric chips 12 to drive the light emitting diode module 23 to emit light. The MCU 22 can adjust the quantity of the photoelectric chips 12 connected to the power management module 21 according to the intensity of the current change detected at the photosensitive electrode group 14, thereby automatically adjusting the brightness of the light emitting diode module 23 to avoid the light emitted by the light emitting diode module 23 being too bright which may affect the use of the sight 20. When the light is insufficient or being used at night, the MCU 22 cannot detect the current change at the photosensitive electrode group 14, the power management module 21 is controlled to switch to the power supply 24 to ensure the normal use of the sight 20, thereby improving the practicality and comfort of the user when using the sight 20.

A shooting device is provided in a third embodiment of the present disclosure. The shooting device includes the sight, thereby improving the aiming accuracy of the shooting device. Whether it is day or night, whether it is sunny or cloudy, whether it is indoors or outdoors, or other circumstances, the shooting device can maintain good aiming performance and stability, thereby improving the shooting efficiency and practicality of the shooting device.

In summary, the present disclosure provides a solar photovoltaic module, a sight and a shooting device. The solar photovoltaic module includes: a substrate, the substrate includes a sight connection end and a chip fixing end arranged opposite to each other, the sight connection end is used to connect a top of the sight; a plurality of photoelectric chips, the plurality of photoelectric chips are evenly spaced and arranged on the chip fixing end; a plurality of photosensitive sensors, the plurality of photosensitive sensors are arranged on the chip fixing end, and the photoelectric chips are spaced from the photosensitive sensors. Thus, the photosensitive sensors can improve the effect of detecting the illumination of a shooting target or an area surrounding the shooting target, thereby greatly improving the adaptive adjustment effect of the brightness of light emitted by the light emitting diode module.

It should be understood that the application of the present disclosure is not limited to the above examples. For ordinary technicians in this field, improvements or changes can be made based on the above description. All these improvements and changes should fall within the scope of protection of the claims attached to the present disclosure.

What is claimed is:

1. A solar photovoltaic module, adopted in a sight, comprising:
a substrate, the substrate comprises a sight connection end and a chip fixing end arranged opposite to each other, the sight connection end is adopted to connect a top of the sight;
a plurality of optoelectronic chips, the plurality of optoelectronic chips are evenly spaced and arranged on the chip fixing end; and
a plurality of photosensitive sensors, the plurality of photosensitive sensors are arranged on the chip fixing end, and the plurality of optoelectronic chips are spaced from the plurality of photosensitive sensors.

2. The solar photovoltaic module according to claim 1, wherein the substrate is a planar substrate, a flexible substrate or a curved substrate.

3. The solar photovoltaic module according to claim 1, wherein the plurality of optoelectronic chips are connected in series.

4. The solar photovoltaic module according to claim 1, wherein a photosensitive electrode group and a photoelectric electrode group are arranged on the sight connection end; the photosensitive electrode group is electrically connected to the plurality of photosensitive sensors, and the photoelectric electrode group is electrically connected to the plurality of photoelectric chips.

5. A sight, wherein the sight comprises a sight body and the solar photovoltaic module according to claim 4, the solar photovoltaic module is arranged on an outer surface of the sight body.

6. The sight according to claim 5, wherein the sight further comprises:
a power management module, the power management module is electrically connected to the photoelectric electrode group;
a microcontroller unit (MCU), the MCU is connected in series to the power management module, and the MCU is electrically connected to the photosensitive electrode group.

7. The sight according to claim 6, wherein the power management module is connected in parallel to the plurality of optoelectronic chips; and the MCU is adopted to control a quantity of the plurality of optoelectronic chips in on or off state.

8. The sight according to claim 7, wherein the sight further comprises a light emitting diode module, and the light emitting diode module is electrically connected to the MCU.

9. The sight according to claim 8, wherein the sight further comprises a power supply, and the power supply is electrically connected to the power management module; wherein when the plurality of photosensitive sensors sense light, the MCU controls the power management module to switch to powering the plurality of optoelectronic chips, driving the light emitting diode module to emit light; when the plurality of photosensitive sensors do not sense light, the MCU controls the power management module to switch to powering the power supply, driving the light emitting diode module to emit light.

10. A shooting device, wherein the shooting device comprises the sight according to claim 5.
